(19) United States
(12) Patent Application Publication
(10) Pub. No.: US 2009/0322062 A1
(43) Pub. Date: Dec. 31, 2009

(54) AIRBAG FOR A MOTOR VEHICLE

(75) Inventors: Georg Bauer, Weinsberg (DE); Clark Ruedebusch, Holzgerlingen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 12/293,981

(22) PCT Filed: Mar. 17, 2007
(86) PCT No.: PCT/EP07/02383

§ 371 Date: Mar. 10, 2009

(30) Foreign Application Priority Data
Mar. 23, 2006 (DE) 102006013287.4

(51) Int. Cl. B60R 21/16

(52) U.S. Cl. 280/729

(57) ABSTRACT

In an airbag for a motor vehicle, with a flow passage via which two pressure chambers are connected to one another, a flow medium, in particular gas, flows from one pressure chamber through the flow passage into the other pressure chamber in a passage direction. To increase the suitability of the airbag for, for example, side impact loads, the flow passage includes a backflow safeguard that allows the flow medium to flow in the passage direction, whereas the flow of the flow medium in a blocking direction opposite to the passage direction is largely prevented.

### BACKGROUND AND SUMMARY OF THE INVENTION

This invention relates to an airbag for a motor vehicle.

In passive restraint systems, airbags that are filled with gas abruptly in the event of an accident in order to restrain an occupant have become known. Airbags of this type are used both as a driver or front-seat passenger airbag in the case of a front collision and a window or side bag in the case of a side collision. It is known, furthermore, that the internal pressure of the airbag can be regulated, by various measures, in order to implement inflation with a high or a lower internal pressure as a function of load-relevant parameters.

German document DE 101 11 566 A1, for example, shows an airbag for a motor vehicle with an outflow orifice, which in the broadest sense forms a flow passage. This flow passage connects two pressure chambers, to be precise the inner space of the airbag and the space around the airbag, to one another. In the event of an abrupt inflation of the airbag, the gas flows from the inner space of the airbag through the flow passage out into the surroundings. The flow passage is in this case designed such that the flow cross section is established automatically as a function of the velocity of the gas stream emerging through the flow passage.

For large-area airbags, for example for a window bag, it may be necessary to close the flow passage, so that the internal pressure remains stable and no equalization with the second pressure chamber occurs.

The object of the invention, therefore, is to develop further an airbag for a motor vehicle, to the extent that suitability for lateral impact is improved.

This object is achieved, according to the invention, by features claimed. Advantageous refinements also are apparent from the claims.

If the flow passage comprises a backflow safeguard, an uncontrolled flow around or flow back, particularly in large airbags, can be avoided. The flow passage connects two pressure chambers to one another, the backflow safeguard allowing the flow medium to flow in the passage direction, whereas the flow of the flow medium in a blocking direction opposite to the passage direction is largely prevented. The advantage of this is that, when a high internal pressure is desired in one pressure chamber for a lengthy period of time, that pressure can be maintained by means of the backflow safeguard, without the flow passage making it possible, when gas no longer continues to flow, to have a flow in the blocking direction opposite to the passage direction. Moreover, if a further collision takes place after a main collision, it is possible to prevent gas from escaping from one pressure chamber and passing into the other pressure chamber. This, of course, is not only restricted to side airbags. Thus, for example, airbags could be closed so that the inflow orifice at the gas generator is not sealed off. When two pressure chambers are referred to within the scope of the invention, one of the pressure chambers may also be the surroundings. Thus, for example, one pressure chamber may be an individual airbag which is inflated through an orifice, which, according to the invention, closes when an outflow is attempted.

Advantageously, the kickback safeguard can be activated by means of a pressure difference between the two pressure chambers.

Depending on what internal pressure is to be set in a pressure chamber, the size of the flow passage can be varied.

In a preferred embodiment of the invention, the flow passage is designed as a flow duct. In a particularly preferred embodiment, the flow duct connects two gas cushions to one another, and in this case the first gas cushion is to have a lower internal pressure than the second gas cushion in the inflated state.

If the gas cushions form a side airbag, advantageously the first gas cushion may be arranged in the chest region and the second gas cushion in a pelvic region of an occupant to be restrained. The advantage of this is that the gas cushion in a pelvic region can absorb higher loads than the gas cushion in the chest region. In one embodiment of the invention, the flow passage is formed by two opposite walls, at least one of which is of double-layer design. The double layer causes a closing of the flow passage in a blocking direction when the internal pressure rises.

If the double layer is fastened with one side to the wall and the other side is freely movable, when gas flows back, this overlap region is inflated, so that the flow passage is automatically sealed off. The more gastight the material (for example, coated fabric) used in this region is, the better this seal functions. The filling of the chambers with different internal pressures may be implemented, for example, via differently dimensioned inflow cross sections.

If both walls are of double-layer design, a closing of the flow passage in the blocking direction can take place even in the case of unfavorable flow conditions.

An advantageous embodiment of the invention is explained below with reference to the drawings.

### BRIEF DESCRIPTION OF THE DRAWINGS

FIG. 1 shows a flow duct with the passage direction,

FIG. 2 shows a flow duct in the blocking direction, and

FIG. 3 shows a top view of the flow duct.

### DETAIL DESCRIPTION OF THE INVENTION

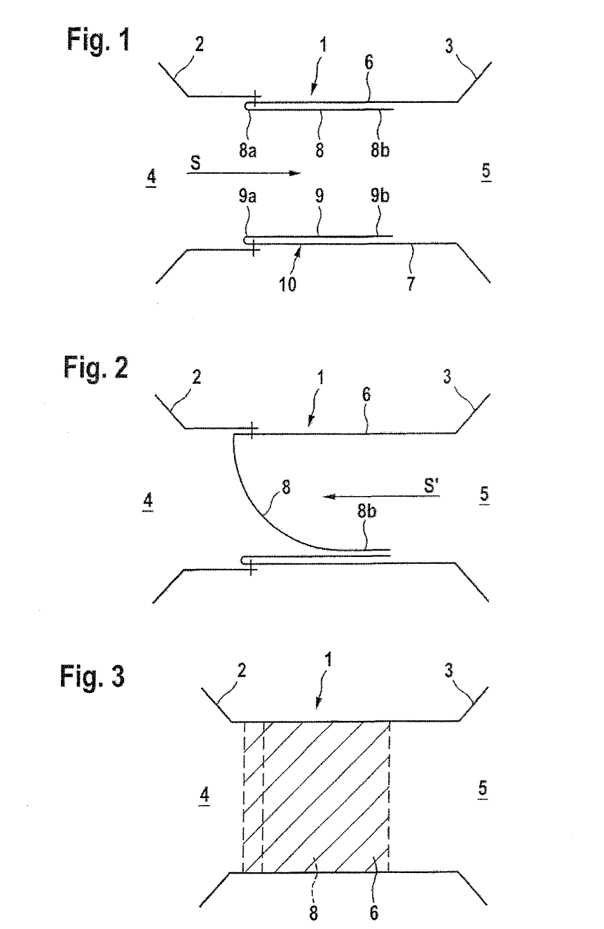

FIG. 1 illustrates a flow duct 1 which connects two gas cushions 2 and 3, designed as pressure chambers 4 and 5, to one another. The flow duct 1 is formed by two opposite walls 6 and 7 which are double-layer in a part region illustrated by hatching in FIG. 3. For this purpose, the wall 6, 7 is folded around inwardly, thus resulting in a double layer 8, 9. This double layer 8, 9 is consequently fastened with one side 8a, 9a to the wall 6, 7, while the other side 8b, 9b is freely movable. The gas cushion 2 of the pressure chamber 4 is fastened to the wall 6, 7 at the transitional region between the wall 6, 7 and the layer 8, 9. If, therefore, the inflow of the gas occurs from the pressure chamber 4 into the pressure chamber 5 via the flow duct 1 in the direction of the arrow S, the double layers 8, 9 are pressed on to the walls 6, 7. The gas stream can flow, unimpeded, in the passage direction S into the pressure chamber 5.

Looking at FIG. 2, it becomes clear how the backflow safeguard 10 formed by double layers 8 and 9 works. The flow blows the double layer in the blocking direction S′ away from the wall assigned to it, so that the flow duct 1 is sealed off automatically. The higher the pressure from the pressure chamber 5 becomes in this case, for example due to the load of an occupant, the more tightly the backflow safeguard closes. If the chamber 5 of the gas cushion 3 has a higher internal pressure than the pressure chamber 4 of the gas cushion 2, substantially higher loads can be absorbed. It is thus shown that the overlap forms a backflow safeguard which works reliably and as a function of its load.

1-9. (canceled)

10. An airbag for a motor vehicle, comprising:
a flow passage, via which two pressure chambers are connected to one another so that a flow medium can flow from one pressure chamber through the flow passage into the other pressure chamber in a passage direction, and
a backflow safeguard included in the flow passage that allows the flow medium to flow in the passage direction,
wherein a flow of the flow medium in a blocking direction opposite to the passage direction is largely prevented.

11. The airbag as claimed in claim 10, wherein the backflow safeguard can be activated by a pressure difference between the pressure chambers.

12. The airbag as claimed in claim 10, wherein the size of the flow passage can be set as a function of the desired internal pressure of one of the pressure chambers.

13. The airbag as claimed in claim 10, wherein the flow passage is a flow duct.

14. The airbag as claimed in claim 13, wherein the flow duct connects two gas cushions to one another, and wherein, in the inflated state, the first gas cushion has a lower internal pressure than the second gas cushion.

15. The airbag as claimed in claim 14, wherein the gas cushions form a side airbag, a first of the gas cushions being arranged in a chest region of an occupant to be restrained and the second gas cushion being arranged in a pelvic region of the occupant.

16. The airbag as claimed in claim 10, wherein the flow passage is formed by two opposite walls, at least one of which has a double-layer design.

17. The airbag as claimed in claim 16, wherein the two opposite walls form a double layer that has one side fastened to at least one of the wall and the other side freely movable.

18. The airbag as claimed in claim 17, wherein both walls are of double-layer design.

19. The airbag as claimed in claim 11, wherein the size of the flow passage can be set as a function of the desired internal pressure of one of the pressure chambers.

20. The airbag as claimed in claim 11, wherein the flow passage is a flow duct.

21. The airbag as claimed in claim 20, wherein the flow duct connects two gas cushions to one another, and wherein, in the inflated state, the first gas cushion has a lower internal pressure than the second gas cushion.

22. The airbag as claimed in claim 21, wherein the gas cushions form a side airbag, a first of the gas cushions being arranged in a chest region of an occupant to be restrained and the second gas cushion being arranged in a pelvic region of the occupant.

23. The airbag as claimed in claim 11, wherein the flow passage is formed by two opposite walls, at least one of which has a double-layer design.

24. The airbag as claimed in claim 12, wherein the flow passage is formed by two opposite walls, at least one of which has a double-layer design.

25. The airbag as claimed in claim 13, wherein the flow passage is formed by two opposite walls, at least one of which has a double-layer design.

26. The airbag as claimed in claim 14, wherein the flow passage is formed by two opposite walls, at least one of which has a double-layer design.

27. The airbag as claimed in claim 15, wherein the flow passage is formed by two opposite walls, at least one of which has a double-layer design.

28. The airbag as claimed in claim 23, wherein the two opposite walls form a double layer that has one side fastened to at least one of the wall and the other side freely movable.

29. The airbag as claimed in claim 28, wherein both walls are of double-layer design.
